(19) United States
(12) Patent Application Publication
(10) Pub. No.: US 2026/0023600 A1
(43) Pub. Date: Jan. 22, 2026

(54) Self-Adjusting Aware Thermal Control of a Semiconductor Device

(71) Applicant: Google LLC, Mountain View, CA (US)

(72) Inventors: Mohsen Heidarinejad, San Jose, CA (US); Arpit Mittal, San Jose, CA (US); Jikai Ma, Coquitlam (CA); Wei Wang, Palo Alto, CA (US)

(73) Assignee: Google LLC, Mountain View, CA (US)

(21) Appl. No.: 18/776,951

(22) Filed: Jul. 18, 2024

(51) Int. Cl. G06F 9/48

(52) U.S. Cl. CPC G06F 9/4893

(57) ABSTRACT

Aspects of self-adjusting aware thermal control of a semiconductor device are disclosed. For example, a central unit may be coupled with an element of the semiconductor device and one or more temperature controllers configured to sequentially apply throttling steps to thermally control the element. The throttling steps are sequentially applied based on individual throttling tables. The central unit has access to the individual throttling tables and may access a current performance state of the element. The central unit may command one or more of the temperature controllers to throttle the element based on the current performance state of the element. The central unit may command one or more of the temperature controllers to apply a throttling step to the element based on throttling steps previously applied to the element. The temperature controllers may include memory to store a current throttling status of the element communicated by the central unit.

### BACKGROUND

Semiconductor devices are widely used throughout the world in various electronic devices such as mobile devices. For example, it is estimated that almost 80% of the world's population owns a mobile phone, which is one type of mobile device. One semiconductor device used within a mobile device is system-on-a-chip (SoC), which includes various elements, such as a central processing unit (CPU), a graphic processing unit (GPU), an accelerated processing unit (APU), an audio processing unit, and a tensor processing unit (TPU).

The use of various elements of a semiconductor device (e.g., CPU, GPU) within an electronic device may cause a rise in temperature within the semiconductor device. The electronic device may include one or more temperature controllers that are configured to thermally control an element of the semiconductor device. For example, a first temperature controller may be configured to prevent the temperature of an element from exceeding a first threshold temperature. A second temperature controller may be configured to prevent the average temperature from exceeding a second threshold temperature that may differ from the first threshold temperature.

### SUMMARY

This document describes systems and techniques for self-adjusting aware thermal control of a semiconductor device. For example, one or more temperature controllers may be configured to sequentially apply throttling steps to an element of a semiconductor device to thermally control the element. The one or more temperature controllers may sequentially apply the throttling steps based on a throttling table. A central unit is coupled with the one or more temperature controllers and the element. The element communicates a current performance state of the element to the central unit. The central unit has access to the throttling tables and identifies any throttling steps that have been applied to the element by the one or more temperature controllers. The central unit may dynamically command the one or more temperature controllers to apply a throttling step based on the current performance state of the element rather than sequentially start to throttle from a throttling table. Likewise, the central unit may dynamically command one temperature controller to apply a throttling step based on a throttling step previously applied, from a different temperature controller, to the element rather than sequentially start to throttle from a throttling table.

In some aspects, the techniques include a system for dynamic thermal control of a semiconductor device, the system including a first temperature controller configured to throttle an element of a semiconductor device and a first throttling table. The first temperature controller is configured to sequentially apply throttling steps to the element based on the first throttling table. The system includes a central unit coupled with the first temperature controller and the element. The central unit is configured to dynamically control, via the first temperature controller, the throttling steps applied to the element for thermal control of the semiconductor device.

In other aspects, the techniques include a system for dynamic thermal control of a semiconductor device, the system including a first plurality of temperature controllers individually configured to control a temperature of a first element within a semiconductor device and a first plurality of throttling tables. Each throttling table of the first plurality of throttling tables corresponds to an individual temperature controller of the first plurality of temperature controllers. The system includes a first central unit coupled with the first element and the first plurality of temperature controllers. The first central unit is configured to dynamically control throttling steps applied to the first element by the individual temperature controllers of the first plurality of temperature controllers for thermal control of the semiconductor device.

In yet other aspects, the techniques include a method for thermally controlling a semiconductor device. The method includes receiving, at a central unit, a current performance state of an element of the semiconductor device, the central unit operatively coupled to the element. The method includes controlling dynamically, via the central unit, a throttling step of a plurality of throttling steps applied, via a first temperature controller, to the element. The central unit is operatively coupled to the first temperature controller and the first temperature controller is configured to sequentially apply throttling steps to the element based on a first throttling table. The central unit may have access to the first throttling table. The method includes communicating, from the first temperature controller to the central unit, throttling steps applied to the element by the first temperature controller.

This Summary is provided to introduce simplified concepts for self-adjusting aware thermal control of a semiconductor device, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF DRAWINGS

Systems and techniques for self-adjusting aware thermal control of a semiconductor device are described with reference to the following drawings. The same numbers are used throughout the drawings to reference like features and components.

FIG. 1 illustrates an example schematic of a system in which aspects of self-adjusting aware thermal control of a semiconductor device can be implemented.

FIG. 2 illustrates an example schematic of a system in which aspects of self-adjusting aware thermal control of a semiconductor device can be implemented.

FIG. 3 illustrates an example schematic of a system in which aspects of self-adjusting aware thermal control of a semiconductor device can be implemented.

FIG. 4 illustrates an example operating environment in which aspects of self-adjusting aware thermal control of a semiconductor device can be implemented.

FIG. 5 illustrates an integrated circuit component in which aspects of self-adjusting aware thermal control of a semiconductor device can be implemented.

FIG. 6 illustrates an example electronic device having internal hardware configurations for self-adjusting aware thermal control of a semiconductor device in accordance with one or more implementations.

FIG. 7 illustrates an example flow chart for a method for thermally controlling a semiconductor device in accordance with one or more implementations.

FIG. 8 illustrates an example flow chart for a method for thermally controlling a semiconductor device in accordance with one or more implementations.

### DETAILED DESCRIPTION

### Overview

Various elements of a semiconductor device within an electronic device may cause a rise in temperature based on repeated and/or continued use. Some electronic devices, such as mobile devices, may not include fans, or the like, to cool components of the electronic device. In these instances, one or more temperature controllers may be configured to throttle element(s) of a semiconductor device to address thermal constraints of (e.g., thermally control) the semiconductor device. Temperature controllers configured to throttle element(s) of a semiconductor device to thermally control the semiconductor device may also be used in electronic devices that also include other mechanisms, such as a fan, which may be used to cool the semiconductor device.

A temperature controller configured to thermally control an element of a semiconductor device sequentially applies throttling steps from a static throttle table to thermally control the semiconductor device. The application of throttling steps may provide a less-than-ideal user experience for the electronic device as the temperature controller proceeds to attempt to thermally control the element of the semiconductor device, especially as the throttling steps become more severe.

Each temperature controller may apply throttling steps to the element in an attempt to decrease the temperature. Individual temperature controllers may sequentially apply a series of throttling steps based on a static throttling table corresponding to the individual temperature controller. For example, a temperature controller may apply a first throttling step as specified by a corresponding throttling table and continue to sequentially apply throttling steps, with each subsequent throttling step being more severe, as specified in a corresponding throttling table until the temperature of the element is below a designated threshold temperature.

As multiple temperature controllers may be configured to thermally control an element of a semiconductor, an individual temperature controller may not be aware of throttling steps already applied to the element by another temperature controller. Further, the temperature controllers may be configured to apply throttling steps to the element at different timescales. For example, a first temperature controller may check the temperature of an element and potentially apply throttling steps every fifty (50) milliseconds and a second temperature controller may check the temperature of the element and potentially apply throttling steps once every second. These and other aspects may lead to inefficiencies regarding the application of throttling steps to an element of a semiconductor device.

The sequential application of throttling steps of a static throttling table, by a temperature controller, to an element of a semiconductor device may not be an efficient technique to thermally control the element. For example, a user may be using a mobile device in a darkened environment so that a display of the mobile device may be dimmed. The continual use of the mobile device may cause a rise in temperature within a semiconductor device within the electronic device triggering a temperature controller configured to thermally control the semiconductor device. A first throttling step of the temperature controller may be to dim the display to a first dimmable level in an attempt to thermally control the semiconductor device. However, the display has already been dimmed by the user due to the dark environment, and the first throttling step applied by the temperature controller may not be efficient. Furthermore, the display may already have been dimmed beyond the first dimmable level of the first throttling step, which may cause the application of the first throttling step to be a waste of time and/or energy by the temperature controller.

Multiple temperature controllers configured to thermally control the same element of semiconductor device provide yet another example of the potentially inefficient application of throttling steps based on a static throttling table. For example, a first temperature controller configured to thermally control an element of the semiconductor device may be triggered by a thermal event and begin sequentially applying throttling steps to the element based on a static throttling table. A second temperature controller configured to thermally control the same element may be triggered after the first temperature controller has already applied a number of throttling steps to the element. The second temperature controller is unaware that the first temperature controller has already applied any triggering steps to the element and begins with a throttling step as set forth in its corresponding throttling table. However, the current throttling status of the element may be throttled below the first step of the second temperature controller's corresponding throttling table and the application of the first throttling step may be inefficient, a waste of time, and/or a waste of energy.

To this end, this document describes systems and techniques of dynamic thermal control of a semiconductor device. In aspects, a central unit may be coupled with an element of the semiconductor device and one or more temperature controllers configured to sequentially apply throttling steps to the element to thermally control the element. The throttling steps are sequentially applied based on individual throttling tables. The central unit has access to the individual throttling tables and may access a current performance state of the element. For example, the central unit may command one or more of the temperature controllers to throttle the element based on the current performance state of the element. As another example, the central unit may command one or more of the temperature controllers to apply a throttling step to the element based on throttling steps previously applied to the element by a temperature controller. The temperature controllers may include memory to store a current throttling status of the element communicated by the central unit. These and other implementations are described herein.

The following discussion describes operating environments, techniques that may be employed in the operating environments, and example methods. Although systems and techniques for self-adjusting aware thermal control of a semiconductor device are described, it is to be understood that the subject of the appended Claims is not necessarily limited to the specific features or methods described. Rather, the specific features and methods are disclosed as example implementations and reference is made to the operating environment by way of example only.

### Example Systems, and Operational Schemes

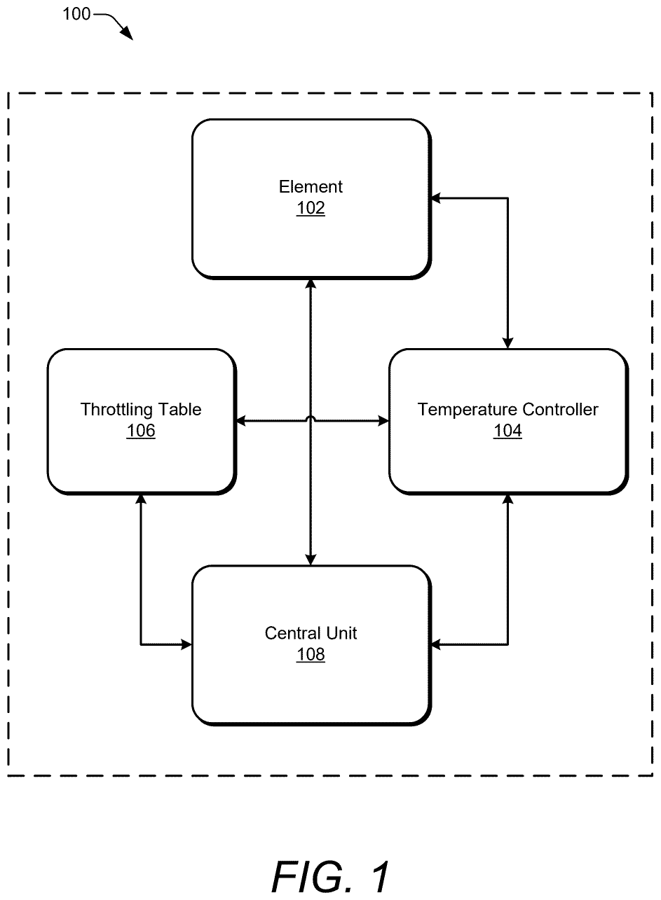

FIG. 1 illustrates an example schematic of a system 100 in which aspects of dynamic thermal control of a semiconductor device can be implemented. The system 100 includes an element 102 of the semiconductor device. The element 102 may be any component of the semiconductor device that has the ability to raise the temperature (e.g., a power source) within the semiconductor device. For example, the element 102 may be any component that may cause a thermal event (e.g., temperature increase) due to the use, repeated use, and/or continual use of the component. Some examples of such components are CPUs, GPUs, and TPUs. In implementations, the semiconductor device can be an SoC with one or more elements (e.g., element 102), an element (e.g., element 102) itself, a temperature controller, or the like.

The system 100 includes a temperature controller 104 configured to thermally control the element 102. The temperature controller 104 can monitor the temperature of the element 102 or the semiconductor device and may be triggered to apply thermal control if a threshold temperature is reached or approached. The temperature controller 104 thermally controls the semiconductor device, or individually the element 102, by the application of a throttling step to the element 102. A throttling step may reduce the performance of the element 102 in an attempt to gain thermal control (e.g., reduce the temperature below a threshold). The application of one or more throttling steps may reduce a user experience of an electronic device that implements the semiconductor device. Thus, throttling steps may be applied progressively, with each subsequent step being more severe than the previously applied throttling step, until a desired thermal control of the semiconductor device is obtained.

The system includes a throttling table 106 that sets forth the sequential throttling steps to be applied by the temperature controller 104 to the element 102 to achieve thermal control. The throttling table 106 is static, meaning the temperature controller 104 sequentially applies the throttling steps as set forth within the throttling table 106 until the desired thermal control of the semiconductor device is obtained.

As discussed herein, the sequential application of throttling steps, by the temperature controller 104, as set forth in the throttling table 106 may not be efficient. For example, the element 102 may already be at a lower than optimal activity status when the temperature controller 104 applies a first throttling step set forth in the throttling table 106. The system 100 includes a central unit 108 that may be in communication with the element 102 and the temperature controller 104. Likewise, the central unit 108 may have access to the throttling table 106 of the temperature controller 104.

The element 102 may communicate a current activity status to the central unit 108, or, alternatively, the central unit 108 may query the element 102 to determine the current activity status of the element 102. The central unit 108 may use the current activity status to dynamically control which throttling step from the throttling table 106 the temperature controller 104 applies to the element 102. In this way, a more efficient throttling is applied to the element 102. In one implementation, the temperature controller 104 may query the central unit 108 prior to throttling the element 102 to obtain thermal control of the semiconductor device. Prior to applying a throttling step as set forth in the corresponding throttling table 106, the temperature controller 104 may request permission and/or instructions from the central unit 108. The central unit 108 may dynamically command the temperature controller 104 on the throttling step to be applied to the element 102.

Dynamic controlling, by the central unit 108, of thermal control of a semiconductor device may ensure a more efficient application of throttling steps to the element 102. This may ensure a better user experience of an electronic device utilizing the semiconductor device.

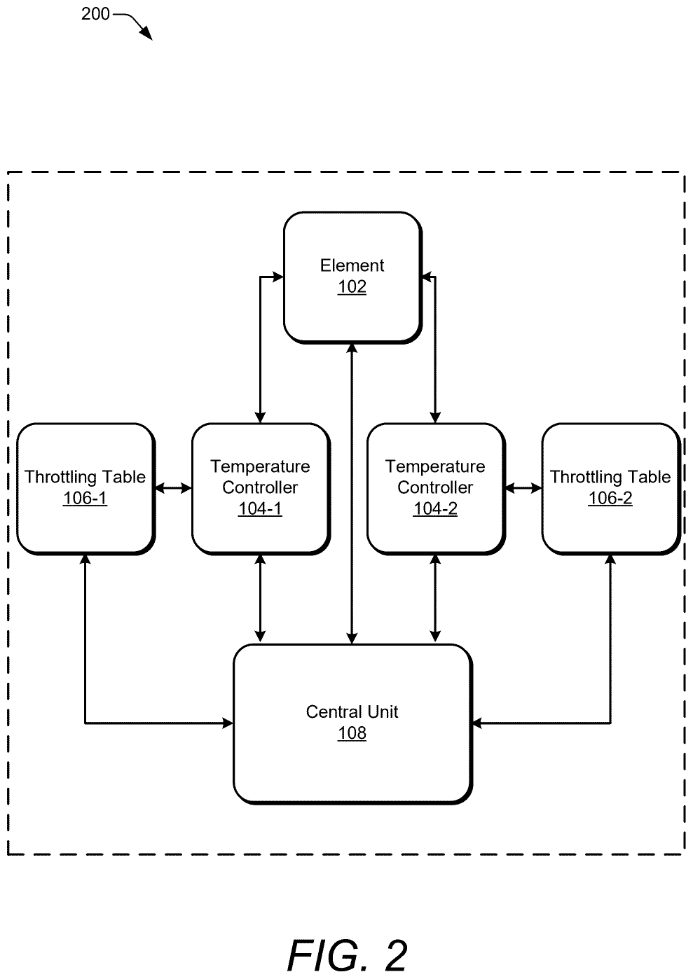

FIG. 2 illustrates an example schematic of a system 200 in which aspects of dynamic thermal control of a semiconductor device can be implemented. The system 200 includes an element 102 (e.g., CPU, GPU, TPU) of the semiconductor device. The system 200 includes a first temperature controller 104-1 configured to thermally control the element 102 and a second temperature controller 104-2 also configured to thermally control the element 102. The first and second temperature controllers 104-1, 104-2 may be independently configured to thermally control the element 102. In one implementation, the first temperature controller 104-1 and the second temperature controller 104-2 may monitor the temperature using different timescales. For example, the first temperature controller 104-1 may monitor the temperature every ten (10) milliseconds while the second temperature controller 104-2 may monitor the temperature every one hundred (100) milliseconds. Because the first and second temperature controller 104-1, 104-2 are configured differently, the second temperature controller 104-2 may be applying throttling steps, based on a throttling table 106-2, that have already been applied by the first temperature controller 104-1, based on its corresponding throttling table 106-1.

In yet another implementation, the first temperature controller 104-1 may be configured to thermally control the element 102 based on a first threshold temperature and the second temperature controller 104-2 may be configured to thermally control the element 102 based on an average second threshold temperature of a specified time period. The two temperature controllers 104-1, 104-2 may apply throttling steps, based on their throttling tables 106-1, 106-2, at different times. Further, the throttling tables 106-1, 106-2 may differ in their sequential throttling steps due to the different functions of the temperature controller 104-1, 104-2. Thus, the applications of throttling steps may be unnecessary, repetitive, and/or ineffective.

In implementations, the first and second temperature controllers 104-1, 104-2 do not communicate between each other. Likewise, the first and second temperature controllers 104-1, 104-2 may not receive a current throttling status from the element 102. In this way, unnecessary, repetitive, and/or ineffective throttling steps may be applied by one or both temperature controllers 104-1, 104-2. The system 200 includes a central unit 108 that may be in communication with the element 102 and the first and second temperature controllers 104-1, 104-2. Likewise, the central unit 108 may have access to the throttling table 106-1 of the first temperature controller 104-1 and the throttling table 106-2 of the second temperature controller 104-2.

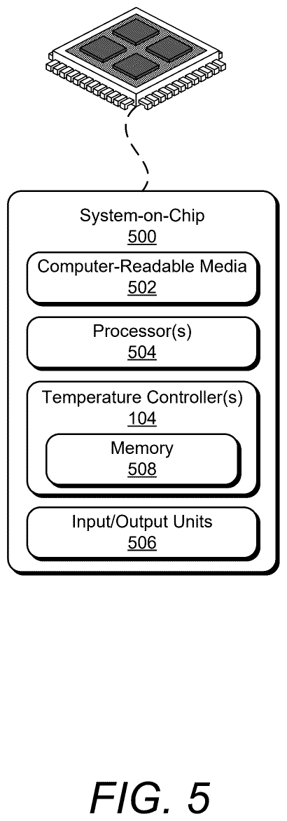

The element 102 may communicate a current throttling status to the central unit 108, or, alternatively, the central unit 108 may query the element 102 to determine the current throttling status of the element 102. Likewise, the first and second temperature controllers 104-1, 104-2 may communicate any throttling steps applied to the element 102, or, alternatively, the central unit 108 may query the first and second temperature controllers 104-1, 104-2 to determine any throttling steps that have been applied to the element 102. The central unit 108 may use the current throttling status or knowledge of the applied throttling steps to dynamically determine which throttling step from the throttling tables 106-1, 106-2 the first temperature controller 104-1 or the second temperature controller 104-2 applies to the element 102. In one implementation, both temperature controllers 104-1, 104-2 may individually query the central unit 108 prior to throttling the element 102. In yet another implementation, the current throttling status of the element 102 may be stored in memory (e.g., memory 508 shown in FIG. 5) of the first and second temperature controllers 104-1, 104-2. The central unit 108 may communicate the current throttling status of the element 102 to the first and second temperature controllers 104-1, 104-2.

The element 102, throttling tables 106-1, 106-2, temperature controllers 104-1, 104-2, and central unit 108 are shown in FIG. 2 for illustrative purposes and may be varied as would be appreciated by one of ordinary skill in the art having the benefit of this disclosure. For example, the system 200 may include more than one element (e.g., element 102), more or fewer than two temperature controllers (e.g., first and second temperature controllers 104-1, 104-2) each with a corresponding throttling table (e.g., first and second throttling tables 106-1, 106-2), and more than one central unit (e.g., central unit 108). In an implementation, the central unit 108 may be coupled with more than one element (e.g., element 102) of a semiconductor device.

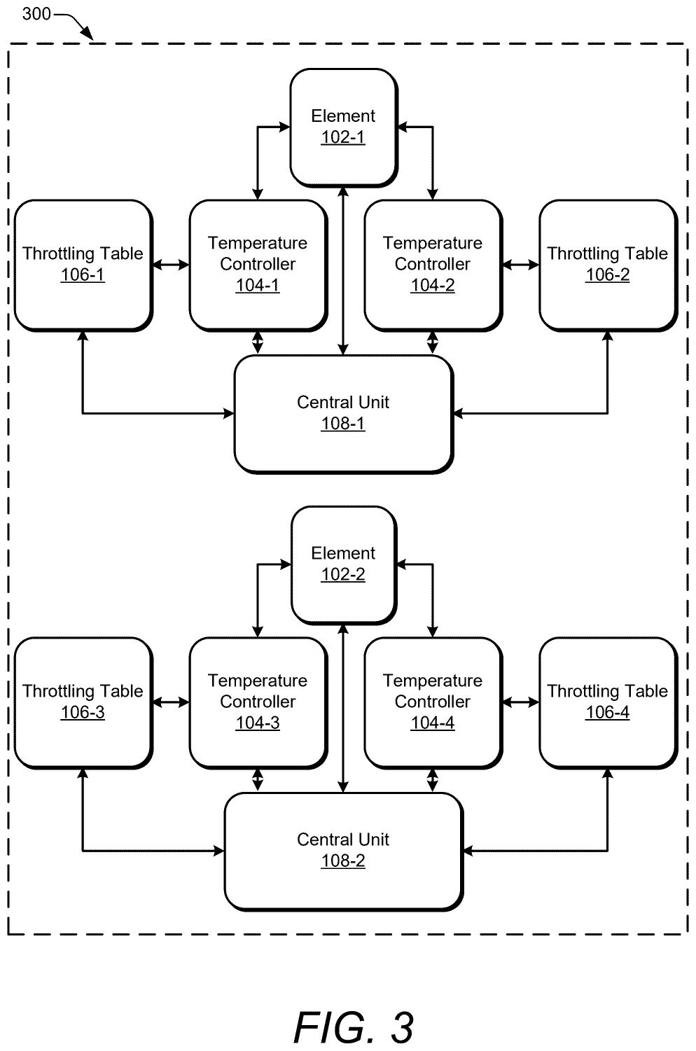

FIG. 3 illustrates an example schematic of a system 300 in which aspects of self-adjusting aware thermal control of a semiconductor device can be implemented. The system 300 includes a first element 102-1 (e.g., CPU, GPU, TPU) of the semiconductor device. The system 300 also includes a second element 102-2. The system 300 includes a first temperature controller 104-1 and a second temperature controller 104-2 configured to thermally control the first element 102-1. The first and second temperature controllers 104-1, 104-2 may be independently configured to thermally control the first element 102-1. For example, the first temperature controller 104-1 may monitor the first element 102-1 to ensure that a temperature does not exceed a first threshold temperature and the second temperature controller 104-2 may monitor the first element 102-1 to ensure that the temperature does not exceed a second threshold temperature that differs from the first threshold temperature. The first temperature controller 104-1 and the second temperature controller 104-2 may monitor the first element 102-1 using different timescales, and/or the first temperature controller 104-1 and the second temperature controller 104-2 may monitor different thermal aspects (e.g., a threshold temperature, an average temperature, a rate of change of temperature) of the first element 102-1.

The first temperature controller 104-1 is configured to sequentially apply throttling steps, based on a first throttling table 106-1, to the first element 102-1 when a thermal event of the first element 102-1 triggers the first temperature controller 104-1. Likewise, the second temperature controller 104-2 is configured to sequentially apply throttling steps, based on a second throttling table 106-2, to the first element 102-1 when a thermal event of the first element 102-1 triggers the second temperature controller 104-2. As discussed above, the first and second temperature controllers 104-1, 104-2 do not communicate between each other, do not receive a current throttling status from the first element 102-1, and may be triggered to apply throttling steps at separate times. Thus, unnecessary, repetitive, and/or ineffective throttling steps may be applied by one or both temperature controllers 104-1, 104-2 to the first element 102-1. The system 300 includes a first central unit 108-1 that may be in communication with the first element 102-1 and the first and second temperature controllers 104-1, 104-2. Likewise, the first central unit 108-1 may have access to the throttling table 106-1 of the first temperature controller 104-1 and the throttling table 106-2 of the second temperature controller 104-2.

The first central unit 108-1 commands the throttling steps that the first and second temperature controllers 104-1, 104-2 apply to the first element 102-1. The first central unit 108-1 may command the first and second temperature controllers 104-1, 104-2 based on a current activity state of the first element 102-1, a current throttle state of the first element 102-1, throttling steps applied to the first element 102-1 by one of the first or second temperature controllers 104-1, 104-2, or a combination thereof.

The system 300 includes a third temperature controller 104-3 and a fourth temperature controller 104-4 configured to thermally control the second element 102-2. The third and fourth temperature controllers 104-3, 104-4 may be independently configured to thermally control the second element 102-2. For example, the third and fourth temperature controllers 104-3, 104-4 may, for different threshold temperatures, use different timescales for monitoring the second element 102-2 and/or monitor different thermal aspects (e.g., a threshold temperature, an average temperature, a rate of change of temperature) of the second element 102-2.

The third temperature controller 104-3 is configured to sequentially apply throttling steps, based on a third throttling table 106-3, to the second element 102-2 when a thermal event of the second element 102-2 triggers the third temperature controller 104-3. Likewise, the fourth temperature controller 104-4 is configured to sequentially apply throttling steps, based on a fourth throttling table 106-4, to the second element 102-2 when a thermal event of the second element 102-2 triggers the fourth temperature controller 104-4. In an implementation, the third throttling table 106-3 differs from the fourth throttling table 106-4. In another implementation, the third and fourth throttling tables 106-3, 106-4 may be identical, but the throttling steps applied by the third temperature controller 104-3 or the fourth temperature controller 104-4 may not be efficiently applied due to the application of throttling steps at separate times.

The system 300 includes a second central unit 108-2 that may be in communication with the second element 102-2 and the third and fourth temperature controllers 104-3, 104-4. The second central unit 108-2 may have access to the throttling table 106-3 of the third temperature controller 104-3 and the throttling table 106-4 of the fourth temperature controller 104-4. The second central unit 108-2 commands the throttling steps applied to the third and fourth temperature controllers 104-3, 104-4 to ensure a more efficient application of throttling steps to the element 102-2, which may ensure a better possible user experience of an electronic device utilizing the system 300 while still thermally controlling the semiconductor device.

The second central unit 108-2 commands the throttling steps that the third and fourth temperature controllers 104-3, 104-4 apply to the second element 102-2. The second central unit 108-2 may command the third and fourth temperature controllers 104-3, 104-4 based on a current activity state of the second element 102-2, a current throttle state of the second element 102-2, throttling steps applied to the second element 102-2 by one of the third or fourth temperature controllers 104-3, 104-4, or a combination thereof.

The elements (e.g., first and second elements 102-1 and 102-2, throttling tables 106-1, 106-2, 106-3, and 106-4, temperature controllers 104-1, 104-2, 104-3, and 104-4, and central units 108-1 and 108-2) are shown in FIG. 3 for illustrative purposes and may be varied as would be appreciated by one of ordinary skill in the art having the benefit of this disclosure. For example, the system 300 may include more than two elements (e.g., first and second elements 102-1, 102-2), more or fewer than four temperature controllers (e.g., first, second, third, and fourth temperature controllers 104-1, 104-2, 104-3, and 104-4) each with a corresponding throttling table (e.g., first, second, third, and fourth throttling tables 106-1, 106-2, 106-3, and 106-4), and more than two central units (e.g., first and second central units 108-1 and 108-2). In an implementation, one or both of the central units (e.g., first and second central units 108-1, 108-2) may be coupled with more than two temperature controllers (e.g., first, second, third, and fourth temperature controllers 104-1, 104-2, 104-3, and 104-4).

### Example Environments and Electronic Devices

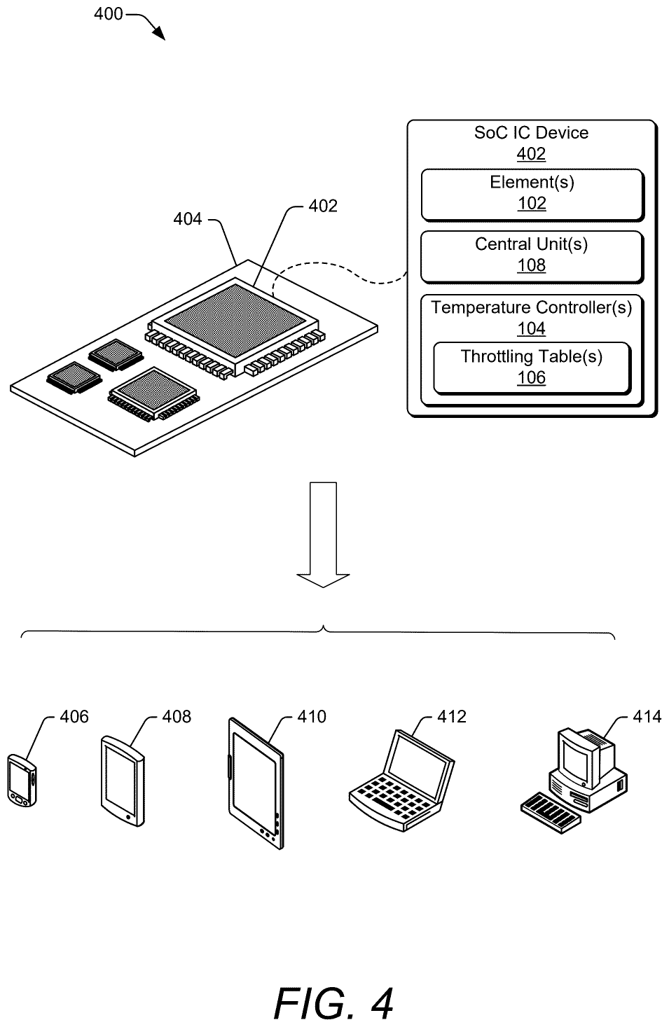

FIG. 4 illustrates an example operating environment 400 in which aspects of thermal control of a semiconductor device can be implemented. As illustrated, an SoC integrated circuit (IC) device 402 is mounted to a printed circuit board (PCB) 404, which may be included as part of a computing device that implements one or more security protocols. As non-limiting examples, the computing device may be a smartphone 406, a personal digital assistant 408, a tablet 410, a laptop 412, or a workstation 414.

The SoC IC device 402 may include various elements 102 (e.g., GPU, CPU, TPU) that may cause a temperature event (e.g., a sudden increase in temperature) within the SoC IC device 402 due to repeated and/or continued use. For example, a user may repeatedly launch, use, and cancel an application on an electronic device that utilizes the SoC IC device 402. The SoC IC device 402 may include one or more temperature controllers 104 that include a corresponding static throttling table 106. The temperature controllers 104 are configured to thermally control one or more elements 102 of the SoC IC device 402 by the sequential application of throttling steps as designated in a corresponding throttling table 106. The SoC IC device 402 may include one or more central units 108 configured to dynamically control the throttling steps applied by one or more temperature controllers 104 to one or more elements 102. The central units 108 are in communication with the elements 102 and the temperature controllers 104. Further, the central units 108 have access to the corresponding throttling tables 106 of the temperature controllers 104.

In some instances, a team of design engineers may design the central units 108 to dynamically control the throttling steps applied to the elements 102 for thermal control of the SoC IC device 402. As an example, the central unit 108 may dynamically command a temperature controller 104 to apply a throttling step to the element 102 based on a current activity state of the element 102. Likewise, the central unit 108 may dynamically command a temperature controller 104 to apply a throttling step to the element 102 based on a current throttling state of the element 102.

Although the SoC IC device 402 is described in the context of a single SoC IC device including the elements 102, central units 108, and temperature controllers 104, a combination of discrete IC devices may perform the same functions. For example, a discrete processor IC device (e.g., a processor IC device having central units 108 and/or temperature controllers 104) may work in combination with a discrete non-volatile memory IC device having the elements 102 to perform one or more functions described herein.

FIG. 5 illustrates an integrated circuit component implemented as an SoC 500 that can implement various aspects of self-adjusting aware thermal control of a semiconductor device. The SoC 500 may be a single chip including components that are fabricated on the same semiconductor substrate. Alternatively, the SoC 500 may be a number of such chips that are epoxied together. The SoC 500 can be implemented in any suitable device, such as a smartphone, a cellular phone, a netbook, a tablet computer, a server, a wireless router, a network-attached storage, a camera, a smart appliance, a printer, a set-top box, or any other suitable type of device. Although described with reference to an SoC, the entities of FIG. 5 may also be implemented as an application-specific integrated circuit (ASIC), a field-programmable gate array (FPGA), or the like.

The SoC 500 can be integrated with electronic circuitry, including the components described in the operating system listed herein. The SoC 500 can also include an integrated data bus (not shown) that couples the various components of the SoC 500 for data communication between the components. The integrated data bus or other components of the SoC 500 may be exposed or accessed through an external port, such as a joint test action group (JTAG) port. For example, components of the SoC 500 may be tested, configured, or programmed (e.g., flashed) through the external port at different stages of manufacture.

In this example, the SoC 500 includes computer-readable media 502, one or more processors 504, one or more temperature controllers 104, and I/O units 506. The temperature controllers 104 are configured for thermal control of a semiconductor device as described herein. The temperature controllers 104 may include memory 508 that may be used to store a current throttling status of an element as discussed herein. The computer-readable media 502 may be stored in computer-readable storage media, including one or more non-transitory storage devices such as a random-access memory (RAM) (dynamic random access memory (DRAM), non-volatile random access memory (NVRAM), or static random access memory (SRAM)), read-only memory (ROM), or flash memory, a hard drive, a solid-state drive (SSD), or any type of media suitable for storing electronic instructions, each coupled with a computer system bus.

The computer-readable media 502 of the SoC 500 may include executable code for the dynamic application of throttling steps by the temperature controllers 104. One or more of the processor(s) 504 operably coupled to computer-readable storage media having computer-readable media 502 may execute instructions of dynamic thermal control of a semiconductor device.

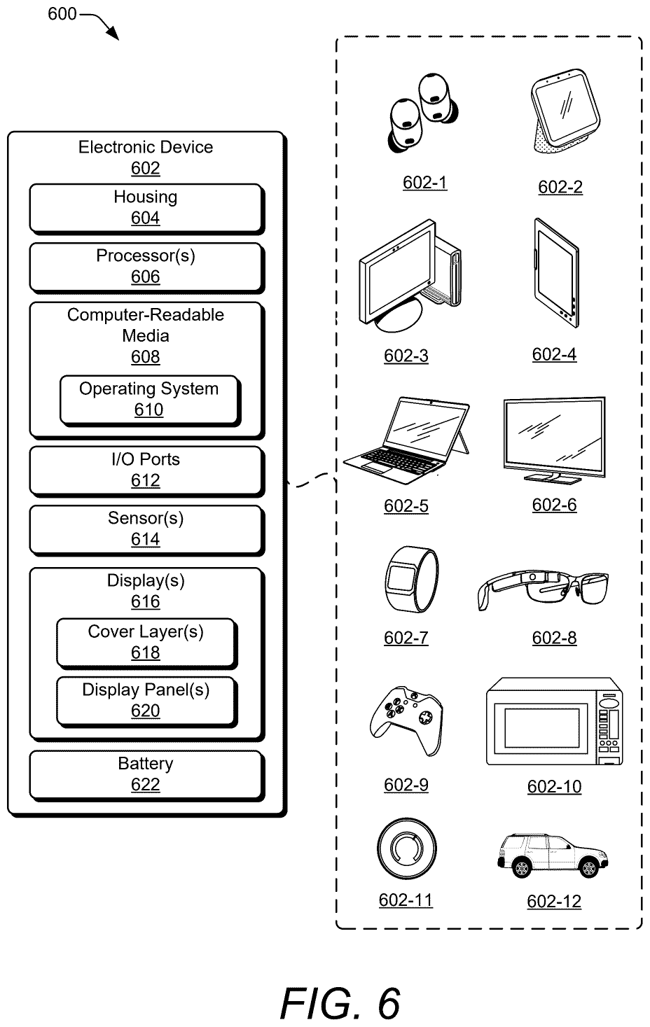

FIG. 6 illustrates an example environment 600 of an example electronic device 602 that includes dynamic thermal control of a semiconductor device in accordance with one or more implementations. The electronic device 602 may include additional components and interfaces omitted from FIG. 6 for the sake of clarity. The electronic device 602 is illustrated with various non-limiting example electronic devices 602, including wireless earbuds 602-1, a smart display associated with a home-automation and control system 602-2, a desktop computer 602-3, a tablet 602-4, a laptop 602-5, a television 602-6, a computing watch 602-7, computing glasses 602-8, a gaming system 602-9, a microwave 602-10, a smart thermostat interface 602-11, and an automobile having computing capabilities 602-12. Other devices may also be used, such as wired earbuds, a security camera, a trackpad, a drawing pad, a netbook, an e-reader, other forms of home-automation and control systems, a wall display, a virtual-reality headset, another vehicle (e.g., an e-bike or plane), and other home appliances, to name just a few examples. Note that the electronic device 602 may be wearable, non-wearable but mobile, or relatively immobile (e.g., desktops and appliances), all without departing from the scope of the present teachings.

The electronic device 602 includes a housing 604, which defines at least one internal cavity within which one or more of a plurality of electronic components may be disposed. In implementations, a mechanical frame may define one or more portions of the housing 604. As an example, a mechanical frame can include plastic or metallic walls that define portions of the housing 604. In additional implementations, a mechanical frame may support one or more portions of the housing 604. As an example, one or more exterior housing components (e.g., plastic panels) can be attached to the mechanical frame (e.g., a chassis). In so doing, the mechanical frame physically supports the one or more exterior housing components, which define portions of the housing 604. In implementations, the mechanical frame and/or the exterior housing components may be composed of crystalline or non-crystalline solids. In implementations, the housing 604 may be sealed through the inclusion of one or more displays (e.g., at least one display 616), defining at least one internal cavity.

The electronic device 602 may further include one or more processors 606. The processor(s) 606 can include, as non-limiting examples, an SoC, an application processor (AP), a CPU, or a GPU. The processor(s) 606 generally execute commands and processes utilized by the electronic device 602 and an operating system installed thereon. For example, the processor(s) 606 may perform operations to display graphics of the electronic device 602 on the one or more displays 616 and can perform other specific computational tasks.

The electronic device 602 may also include computer-readable storage media (CRM) 608. The CRM 608 may be a suitable storage device configured to store device data of the electronic device 602, user data, and multimedia data. The CRM 608 may store an operating system 610 that generally manages hardware and software resources (e.g., the applications) of the electronic device 602 and provides common services for applications stored on the CRM 608. The operating system 610 and the applications are generally executable by the processor(s) 606 to enable communications and user interaction with the electronic device 602. One or more processor(s) 606, such as a GPU, perform operations to display graphics of the electronic device 602 on the one or more displays 616 and can perform other specific computational tasks. The processor(s) 606 can be single-core or multiple-core processors.

The electronic device 602 may also include input/output (I/O) ports 612. The I/O ports 612 allow the electronic device 602 to interact with other devices or users. The I/O ports 612 may include any combination of internal or external ports, such as universal serial bus (USB) ports, audio ports, serial advanced technology attachment (SATA) ports, peripheral component interconnect standard (PCI)-express based ports or card-slots, secure digital input/output (SDIO) slots, and/or other legacy ports.

The electronic device 602 may further include one or more sensors 614. The sensor(s) 614 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), an under-display fingerprint sensor, or an ambient light sensor (e.g., photodetector). In implementations, the electronic device 602 includes one or more of a front-facing sensor(s) and a rear-facing sensor(s).

The electronic device 602 may include the one or more displays 616, one or more cover layers 618, and one or more display panels 620. The cover layer(s) 618 may be implemented as any of a variety of transparent materials including polymers (e.g., plastic, acrylic) or glasses.

The electronic device 602 further includes a battery 622. In implementations, the battery 622 is a rechargeable battery that is configured to store and supply electrical energy. The rechargeable battery 622 may be any suitable rechargeable battery, such as a lithium-ion (Li-ion) battery.

### Example Methods

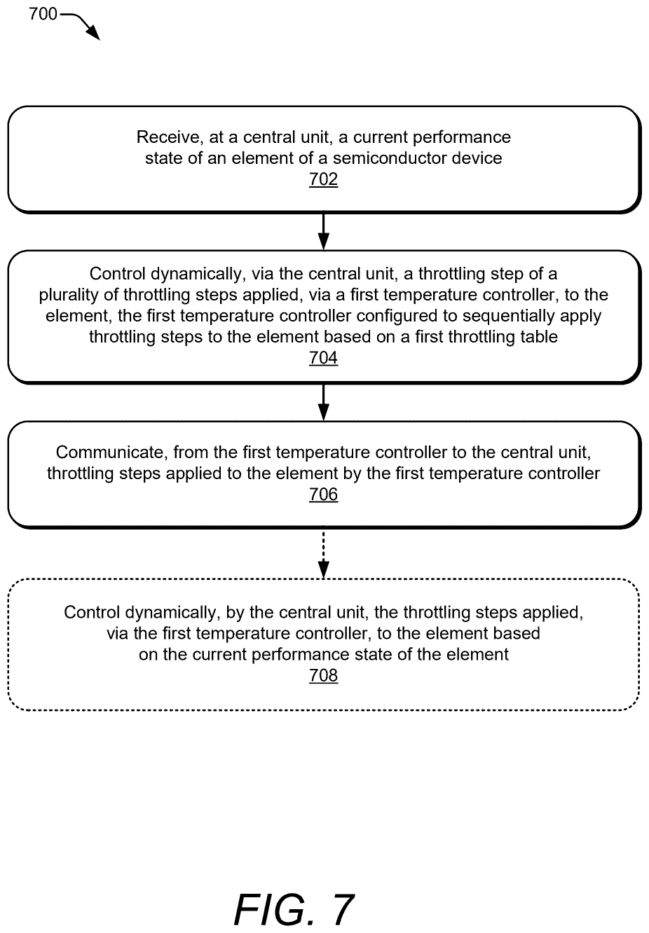

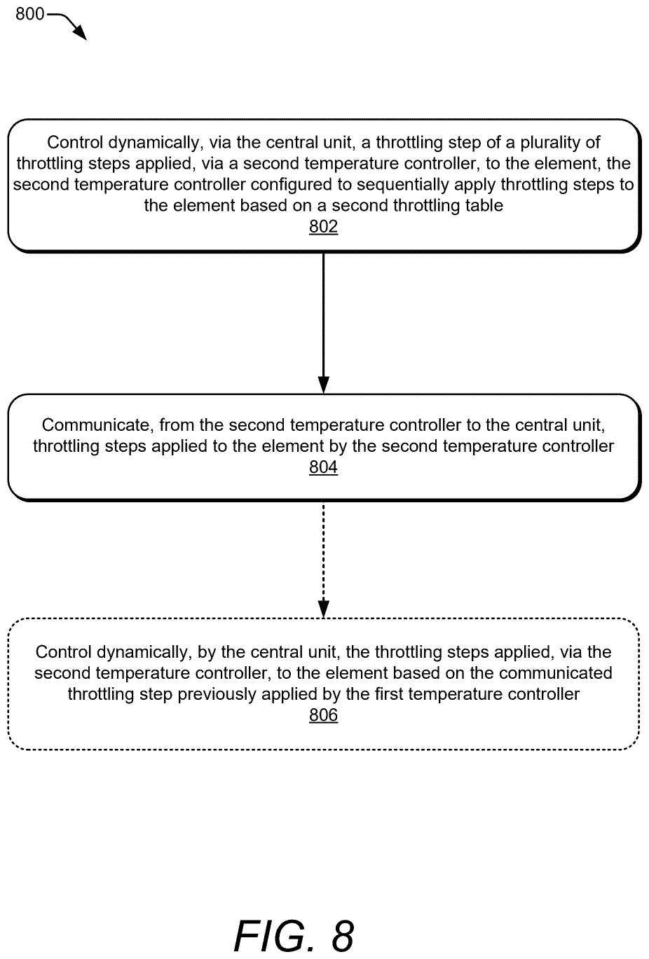

Example methods are described below with reference to the flow charts of FIG. 7 and FIG. 8. Although example method aspects are described separately below, they may be implemented together in any combination or permutation.

Example methods are described below with reference to the flow chart of FIG. 7. FIG. 7 illustrates a flow chart 700 of an example method for dynamic thermal control of a semiconductor device. The flow chart 700 includes four blocks 702, 704, 706, and 708, of which block 708 is optional. The operations of the example processes can be performed by electronic circuit components as described herein. For example, the operations may be performed by a central unit (e.g., central unit 108) and temperature controller(s) (e.g., temperature controllers 104-1, 104-2, 104-3, and 104-4) configured to thermally control an element of a semiconductor device.

At 702, a current performance state of an element of a semiconductor device is received at a central unit. For example, a central unit (e.g., central unit 108) may receive a current performance state of an element (e.g., element 102) of a semiconductor device.

At 704, a throttling step of a plurality of throttling steps applied, via a first temperature controller, to the element is controlled dynamically by the central unit. The first temperature controller is configured to sequentially apply throttling steps to the element based on a first throttling table. For example, the central unit (e.g., central unit 108) dynamically controls a throttling step applied via a first temperature controller (e.g., first temperature controller 104-1) to the element (e.g., element 102), with the first temperature controller (e.g., first temperature controller 104-1) configured to sequentially apply throttling steps to the element (e.g., element 102) based on a first throttling table (e.g., first throttling table 106-1).

At 706, throttling steps applied to the element by the first temperature controller are communicated from the first temperature controller to the central unit. For example, the first temperature controller (e.g., first temperature controller 104-1) communicates throttling steps applied to the element (e.g., element 102) to the central unit (e.g., central unit 108).

At 708, optionally, the central unit dynamically controls the throttling steps applied, by the first temperature controller, to the element based on a current performance state of the element. For example, the central unit (e.g., central unit 108) dynamically controls throttling steps applied, by the first temperature controller (e.g., first temperature controller 104-1), to the element (e.g., element 102) based on a current performance state of the element (e.g., element 102). In one implementation, the element (e.g., element 102) may be a display and the current performance state may be a dimmed state of the display.

Example methods are described below with reference to the flow chart of FIG. 8. FIG. 8 illustrates a flow chart 800 of another example method for dynamic thermal control of a semiconductor device. The flow chart 800 includes three blocks 802, 804, and 806, of which block 806 is optional. The operations of the example processes can be performed by electronic circuit components as described herein. For example, the operations may be performed by a central unit (e.g., central unit 108) and temperature controller(s) (e.g., first, second, third, and fourth temperature controllers 104-1, 104-2, 104-3, and 104-4) configured to thermally control an element of a semiconductor device.

At 802, a throttling step of a plurality of throttling steps applied, via a second temperature controller, to the element is controlled dynamically by the central unit. The second temperature controller is configured to sequentially apply throttling steps to the element based on a second throttling table. For example, the central unit (e.g., central unit 108) dynamically controls a throttling step applied via a second temperature controller (e.g., second temperature controller 104-2) to the element (e.g., element 102), with the second temperature controller (e.g., second temperature controller 104-2) configured to sequentially apply throttling steps to the element (e.g., element 102) based on a second throttling table (e.g., second throttling table 106-2).

At 804, throttling steps applied to the element by the second temperature controller are communicated from the second temperature controller to the central unit. For example, the second temperature controller (e.g., second temperature controller 104-2) communicates throttling steps applied to the element (e.g., element 102) to the central unit (e.g., central unit 108).

At 806, optionally, the central unit dynamically controls the throttling steps applied, by the second temperature controller, to the element based on the communicated throttling step previously applied by the first temperature controller. For example, the central unit (e.g., central unit 108) dynamically controls throttling steps applied, by the second temperature controller (e.g., second temperature controller 104-2), to the element (e.g., element 102) based on the communicated throttling steps previously applied to the element (e.g., element 102) by the first temperature controller (e.g., first temperature controller 104-1).

For the methods described herein and the associated flow chart(s) and flow diagram(s), the orders in which operations are shown and/or described are not intended to be construed as a limitation. Instead, any number or combination of the described method operations can be combined in any order to implement a given method or an alternative method, including by combining operations from the flow chart or diagram and the earlier-described schemes and techniques into one or more methods. Operations may also be omitted from or added to the described methods. Further, described operations can be implemented in fully or partially overlapping manners.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Terms such as “above,” “below,” or “underneath” are not intended to require any particular orientation of a device. Rather, a first layer or component being provided “above” a second layer or component is intended to describe the first layer being at a higher Z-dimension than the second layer or component within the particular coordinate system in use. It will be understood that should the component be provided in another orientation, or described in a different coordinate system, then such relative terms may be changed.

Although implementations for self-adjusting aware thermal control of a semiconductor device have been described in language specific to certain features and/or methods, the subject of the appended claims is not necessarily limited to the specific features or methods described. Rather, the specific features and methods are disclosed as example implementations for dynamic thermal control of a semiconductor device.

What is claimed is:

1. A system comprising:
a first temperature controller configured to throttle an element of a semiconductor device;
a first throttling table, the first temperature controller configured to sequentially apply throttling steps to the element based on the first throttling table; and
a central unit coupled with the first temperature controller and the element, the central unit configured to dynamically control, via the first controller, the throttling steps applied to the element for thermal control of the semiconductor device.

2. The system of claim 1, wherein the central unit commands the first temperature controller to apply a throttling step based on a performance state of the element.

3. The system of claim 1, further comprising:
a second temperature controller configured to throttle the element; and
a second throttling table, the second temperature controller configured to sequentially apply throttling steps to the element based on the second throttling table, wherein the central unit is coupled with the second temperature controller and is configured to dynamically control the throttling steps applied, by the second controller, to the element for thermal control of the semiconductor device.

4. The system of claim 3, wherein the central unit has access to the first throttling table and to the second throttling table.

5. The system of claim 4, wherein the first temperature controller is configured to control a temperature of the element from exceeding a first threshold temperature, and wherein the second temperature controller is configured to control an average temperature of the element from exceeding a second threshold temperature.

6. The system of claim 4, wherein the first temperature controller communicates, to the central unit, an application of throttling steps applied to the element.

7. The system of claim 6, wherein the central unit controls, via the second temperature controller, throttling steps applied to the element based on the application of throttling steps communicated by the first temperature controller.

8. The system of claim 4, wherein the element communicates a current performance status to the central unit.

9. The system of claim 8, wherein, based on the communicated current performance status, the central unit controls an application of throttling steps applied to the element by the first temperature controller and the second temperature controller.

10. The system of claim 4, wherein the first and second temperature controllers request throttling commands from the central unit prior to an application of the throttling steps to the element.

11. The system of claim 4, wherein a current throttling status is stored in memory in the first temperature controller and stored in memory in the second temperature controller.

12. A system comprising:
a first plurality of temperature controllers individually configured to control a temperature of a first element within a semiconductor device;
a first plurality of throttling tables, each throttling table of the first plurality of throttling tables corresponding to an individual temperature controller of the first plurality of temperature controllers; and
a first central unit coupled with the first element and the first plurality of temperature controllers, the first central unit configured to dynamically control throttling steps applied to the first element by the individual temperature controllers of the first plurality of temperature controllers for thermal control of the semiconductor device.

13. The system of claim 12, wherein the first central unit dynamically controls the throttling steps applied by the individual temperature controllers of the first plurality of temperature controllers based on a current performance state of the first element.

14. The system of claim 12, wherein the first central unit dynamically controls the throttling steps applied by the individual temperature controllers of the first plurality of temperature controllers based on a current throttling state of the first element.

15. The system of claim 12, further comprising:
a second plurality of temperature controllers individually configured to control a temperature of a second element within the semiconductor device;
a second plurality of throttling tables, each throttling table of the second plurality of throttling tables corresponding to an individual temperature controller of the second plurality of temperature controllers; and
a second central unit coupled with the second element and the second plurality of temperature controllers, the second central unit configured to dynamically control throttling steps applied to the second element by the individual temperature controllers of the second plurality of temperature controllers for thermal control of the semiconductor device.

16. The system of claim 15, wherein the second central unit dynamically controls the throttling steps of the second plurality of temperature controllers based on a current performance state of the second element or a current throttling state of the second element.

17. A method for thermally controlling a semiconductor device, the method comprising:
receiving, at a central unit, a current performance state of an element of the semiconductor device, the central unit operatively coupled to the element;
controlling dynamically, via the central unit, a throttling step of a plurality of throttling steps applied, via a first temperature controller, to the element, the central unit operatively coupled to the first temperature controller, the first temperature controller configured to sequentially apply throttling steps to the element based on a first throttling table, the central unit having access to the first throttling table; and
communicating, from the first temperature controller to the central unit, throttling steps applied to the element by the first temperature controller.

18. The method of claim 17, wherein the dynamic control of the throttling step applied, via the first temperature controller, to the element is based on the current performance state of the element.

19. The method of claim 17, further comprising:
controlling dynamically, by the central unit, a throttling step of a plurality of throttling steps applied, via a second temperature controller, to the element, the central unit operatively coupled to the second temperature controller, the second temperature controller configured to sequentially apply throttling steps to the element based on a second throttling table, the central unit having access to the second throttling table; and
communicating, from the second temperature controller to the central unit, throttling steps applied to the element by the second temperature controller.

20. The method of claim 19, wherein the dynamic control of the throttling step applied, via the second temperature controller, to the element is based on the communicated throttling step previously applied by the first temperature controller.
